(19) United States
(12) Patent Application Publication
(10) Pub. No.: US 2008/0267035 A1
(43) Pub. Date: Oct. 30, 2008

(54) Information Recording Medium

(76) Inventors: Kazuo Kuroda, Saitama (JP); Eiji Muramatsu, Saitama (JP); Kunihiko Horikawa, Saitama (JP); Atsushi Yamaguchi, Saitama (JP); Masahiro Kato, Saitama (JP); Toshio Suzuki, Saitama (JP)

Correspondence Address: YOUNG & THOMPSON, 209 Madison Street, Suite 500, ALEXANDRIA, VA, 22314, US

(21) Appl. No.: 10/594,534

(22) PCT Filed: Mar. 29, 2005
(86) PCT No.: PCT/JP2005/005867

§ 371 Date: Nov. 22, 2006

(30) Foreign Application Priority Data
Mar. 29, 2004 (JP) 2004-096506

(51) Int. Cl. G11B 7/00

(52) U.S. Cl. 369/100

(57) ABSTRACT

An information recording medium (100) is provided with: a first recording layer (L0) in which record information is recorded toward one direction directed from an inner circumferential side to an outer circumferential side, or directed from the outer circumferential side to the inner circumferential side, by irradiating laser light (LB) thereon; and a second recording layer (L1) in which the record information is recorded toward another direction which is different from the one direction, by irradiating the laser light thereon, directions of recording the record information being equal, in a particular recording area for focus-in of the laser light in said first recording layer and in at least one recording area of said second recording layer corresponding to the particular recording area.

### TECHNICAL FIELD

The present invention relates to an information recording medium, such as a DVD.

### BACKGROUND ART

In an information recording medium, such as an optical disc, like a CD-ROM (Compact Disc-Read Only Memory), a CD-R (Compact Disc-Recordable), a DVD-ROM and the like, for example, a multilayer type optical disc which is constructed from a plurality of recording layers starts being provided (e.g. refer to a patent document 1).

Patent document 1: Japanese Patent Application Laid Open NO. Hei 9-326138

### DISCLOSURE OF INVENTION

### Subject to be Solved by the Invention

In such a multilayer type optical disc, laser light is sometimes focused on a not-desired recording layer out of the plurality of recording layers, and the focusing on the not-desired recording layer causes the malfunction of an optical pickup. In the case of an existing player or recorder which does not support the multilayer type optical disc, there is also such a problem that even if the laser light is focused on the not-desired recording layer, the recording of data or the like is performed with respect to the not-desired recording layer.

In order to solve the above-mentioned problems, it is therefore an object of the present invention to provide an information recording medium, which has a plurality of recording layers, and on which information can be properly recorded and the recorded data can be reproduced, for example.

The above object of the present invention can be achieved by an information recording medium provided with: a first recording layer in which record information is recorded toward one direction directed from an inner circumferential side to an outer circumferential side, or directed from the outer circumferential side to the inner circumferential side, by irradiating laser light thereon; and a second recording layer in which the record information is recorded toward another direction which is different from the one direction, by irradiating the laser light thereon, directions of recording the record information being equal, in a particular recording area for focus-in of the laser light in the first recording layer, and in at least one recording area of the second recording layer corresponding to the particular recording area.

According to the information recording medium of the present invention, it is possible to record the record information into each of the plurality of recording layers (i.e. the first recording layer and the second recording layer). In the first recording layer, the record information is recorded toward the one direction which is directed from the inner circumferential side to the outer circumferential side or is directed from the outer circumferential side to the inner circumferential side. On the other hand, in the second recording layer, the record information is recorded toward another direction which is different from (or opposite to) the one direction.

Particularly in the present invention, the direction of recording the record information in the particular recording area of the first recording layer on which the laser light is focused-in is the same as the direction of recording the record information in the one recording area of the second recording layer which corresponds to the particular recording area. Here, the expression “focus-in” in the present invention is a concept indicating an operation of setting the focus of the laser light on the particular recording area, by irradiating it with the laser light, in recording or reproducing the record information. In particular, it may also indicate an operation of setting the focus of the laser light in the beginning (specifically, firstly after the loading of the information recording medium) of a reproduction operation and a recording operation.

Therefore, in the case where is an information recording/reproducing apparatus described later originally desires to focus-in the laser light into the first recording layer, for example, even if the laser light is focused-in on the one recording area of the second recording layer by mistake, it is possible to avoid a disadvantage of the runaway of an optical pickup (e.g. the runaway toward the inner circumferential side of the optical pickup), because the recording direction of the record information in the one recording area is the same as that of the first recording layer. In other words, since the recording direction of the one recording area is the same as that of the particular recording area, the information recording/reproducing apparatus tries to read control information or the like to be read in focusing-in the laser light, even in the one recording area, as in focusing-in the laser light on the particular recording area. However, since the one recording area is not the recording area to focus-in originally, such control information cannot be read. Thus, the information recording/reproducing apparatus cannot continue the subsequent recording operation, for example, or it judges that the information recording medium is a defective. Thus, it is possible to prevent such a disadvantage that the record information is mistakenly recorded into the second recording layer due to the focusing-in the laser light into the second recording layer Or it is possible to prevent such a disadvantage that the operation of the optical pickup goes out of control due to the focusing-in the laser light on the second recording layer. In this case, for example, if the information recording medium is ejected and reloaded, it is possible to focus-in the laser light on the proper recording layer, and it is possible to perform the proper recording operation.

In particular, in the case of an information recording/reproducing apparatus which does not support the information recording medium having the two or more recording layers, since it cannot judge that it is the information recording medium having the two or more recording layers, there is a possibility that it recognizes the recording layer on which the laser light is focused-in as the proper recording layer. This may lead to the runaway of the optical pickup. However, according to the information recording medium of the present invention, even if the laser light is focused-in on the improper recording layer (e.g. the second recording layer) by mistake, it is possible to recognize that the subsequent recording operation cannot be continued, and it is possible to eject the information recording medium, or the like, for example. Therefore, even in the case of the information recording/reproducing apparatus which does not support the information recording medium having the two or more recording layers, it is possible to realize the proper recording operation. In other words, it is possible to properly record the record information into a desired recording layer of the information recording medium having the two or more recording layers which is expected to become popular in the future, by using such an information recording/reproducing apparatus. By this, the information recording medium of the present invention has a great advantage, in the point that it is possible to provide compatibility between the existing information recording medium, which currently appears on the market, and the information recording medium having the two or more recording layers, which is expected to become popular in the future.

As explained above, according to the information recording medium of the present invention, in the case where it is originally desired to focus-in the laser light on the first recording layer, even if the laser light is focused-in on the second recording layer by mistake, it is possible to properly continue the recording operation. Namely, by taking some actions, such as reloading of the information recording medium, for example, it is possible to properly record the record information onto the information recording medium having the plurality of recording layers.

In another aspect of the information recording medium of the present invention, at least the second recording layer has a spiral or concentric recording track, and the record information is recorded along the recording track, and a mirror area in which the record information is not recorded is provided in a boundary portion between a recording track in the one recording area and a recording track in another recording area of the second recording layer other than the one recording area.

According to this aspect, in one recording layer, it is possible to properly arrange the plurality of recording areas whose recording directions of the record information are different. In addition, since it is only necessary to set the mirror area (e.g. the area in which the record information is unrecorded) in the boundary portion of the plurality of recording areas whose recording directions of the record information are different, there is also such an advantage that the information recording medium can be manufactured, relatively easily.

In another aspect of the information recording medium of the present invention, the one recording area is larger than the particular recording area.

According to this aspect, it is possible to more effectively recognize the disadvantage that the laser light is focused-in on the second recording layer by mistake. In particular, in the case of an information recording medium of a bonding type, the centers of the first recording layer and the second recording layer are sometimes shifted or deviated from each other (i.e. an eccentricity occurs). According to this aspect, however, since the relatively large one recording area is provided, with considering such a shift or deviation, it is possible to prevent the disadvantage due to the shift, even if the eccentricity occurs.

These effects and other advantages of the present invention become more apparent from the following embodiments.

As explained above, the information recording medium of the present invention is provided with: the first recording layer; and the second recording layer, directions of recording the record information being equal, in the particular recording area and in the one recording area corresponding to the particular recording area. Therefore, it is possible to properly record the record information on to the information recording medium having the plurality of recording layers.

### BRIEF DESCRIPTION OF DRAWINGS

FIG. 1 are a substantial plan view showing the basic structure of an optical disc having a plurality of recording areas, in a first embodiment of the information recording medium of the present invention, in the upper part, and a corresponding conceptual view showing a recording area structure in the radial direction, in the lower part.

FIG. 2 are data structure diagrams conceptually showing the data structure of the optical disc of an opposite track path type, as the information recording medium in the first embodiment.

FIG. 3 is a data structure diagram showing the data structure of the optical disc of the opposite track path type, in more detail, as the information recording medium in the first embodiment.

FIG. 4 are plan views conceptually showing a direction of recording the data on the optical disc in the first embodiment.

FIG. 5 are data structure diagrams conceptually showing an example of the data structure of an information recording medium in a comparison example.

FIG. 6 is a plan view conceptually showing one aspect of the distribution of a recording track formed in an L1 layer of the optical disc in the embodiment.

FIG. 7 is a plan view conceptually showing another aspect of the distribution of the recording track formed in the L1 layer of the optical disc in the embodiment.

FIG. 8 is a plan view conceptually showing another aspect of the distribution of the recording track formed in the L1 layer of the optical disc in the embodiment.

FIG. 9 is a plan view conceptually showing another aspect of the distribution of the recording track formed in the L1 layer of the optical disc in the embodiment.

FIG. 10 are data structure diagrams conceptually showing the data structure of an optical disc in a second embodiment of the information recording medium of the present invention.

FIG. 11 is a block diagram showing an information recording/reproducing apparatus for recording data or reproducing the recorded data, with respect to the first or second embodiment of the information recording medium of the present invention.

### DESCRIPTION OF REFERENCE CODES

1 Information recording apparatus
100 Optical disc
102 Lead-in area
113 Lead-out area
113a Area
104, 114 Middle area

### BEST MODE FOR CARRYING OUT THE INVENTION

Hereinafter, the best mode for carrying out the invention will be explained in each embodiment in order, with reference to the drawings.

### EMBODIMENTS OF INFORMATION RECORDING MEDIUM

### (1) First Embodiment

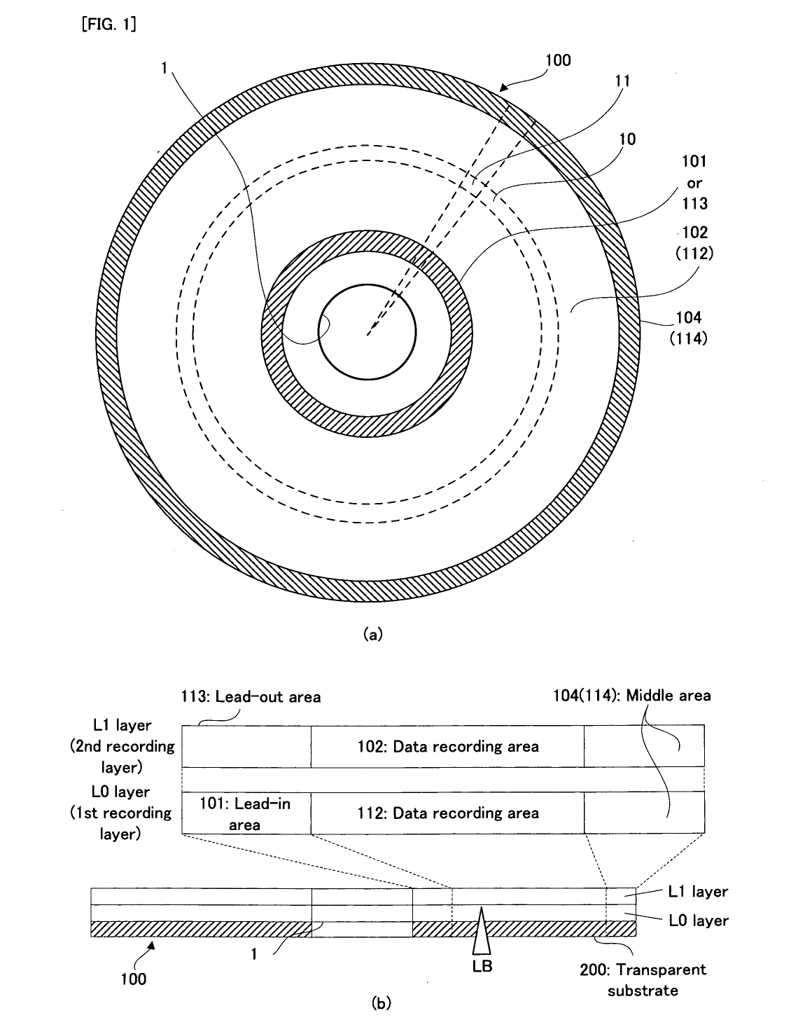

Firstly, with reference to FIG. 1 to FIG. 9, a first embodiment of the information recording medium of the present invention will be explained.

Firstly, with reference to FIG. 1, an optical disc as the first embodiment of the information recording medium of the present invention will be discussed. FIG. 1 are a substantial plan view showing the basic structure of the optical disc having a plurality of recording areas, in the first embodiment of the information recording medium of the present invention, in the upper part, and a corresponding conceptual view showing a recording area structure in the radial direction, in the lower part.

Firstly, with reference to FIG. 1, the basic structure of the optical disc as the first embodiment of the information recording medium of the present invention will be discussed. FIG. 1(a) is a substantial plan view showing the basic structure of the optical disc having a plurality of recording areas, in the first embodiment of the information recording medium of the present invention, and FIG. 1(b) is a schematic cross sectional view of the optical disc and a corresponding conceptual view showing a recording area structure in the radial direction.

As shown in FIG. 1(a) and FIG. 1(b), an optical disc 100 has a recording surface on a disc main body with a diameter of about 12 cm, as is a DVD. On the recording surface, the optical disc 100 is provided with: a center hole 1 as the center; a lead-in area 101 or a lead-out area 113; a data area 102 (112); and a middle area 104 (114), in the embodiment. Then, for example, on a transparent substrate 200 of the optical disc 100, there are laminated recording layers or the like. In each recording area of the recording layers, a track or tracks 10, such as a groove track and a land track, are alternately placed, spirally or concentrically, centered on the center hole 1, for example. On the track 10, data is divided and recorded by a unit of ECC block 11. The ECC block 11 is a data management unit by a pre-format address in which record information is error-correctable.

Incidentally, the present invention is not particularly limited to the optical disc having these three areas. For example, even if the lead-in area 101, the lead-out area 113 or the middle area 104 (114) does not exist, a data structure explained below can be constructed. Moreover, as described later, the lead-in area 101, the lead-out area 113 or the middle area 104 (114) may be further segmentized.

In particular, the optical disc 100 in the embodiment, as shown in FIG. 1(b), has such a structure that an L0 layer and an L1 layer, which constitute one example of the “first recording layer and second recording layers” of the present invention, respectively, are laminated on the transparent substrate, for example. Then, the L0 layer is provided with: the lead-in area 101; the data area 102; and the middle area 104, and the L1 layer is provided with: the lead-out area 113; the data area 112; and the middle area 114. Namely, the optical disc 100 in the embodiment is an optical disc of an opposite track path type Upon the recording/reproduction of such a two-layer type optical disc 100, the recording/reproduction in the L0 layer or the recording/reproduction in the L0 layer the L1 layer is performed, depending on which recording layer has the focus position of laser light LB, which is irradiated from the lower side to upper side in FIG. 1(b). Moreover, the optical disc 100 in the embodiment is not limited to a two-layer single sided type, i.e., a dual layer type, but may be a two-layer double sided type, i.e., a dual layer double sided type. Furthermore, the optical disc 100 in the embodiment is not limited to the optical disc having the two recording layers, as described above, but may be an optical disc of a multilayer type which has three or more layers.

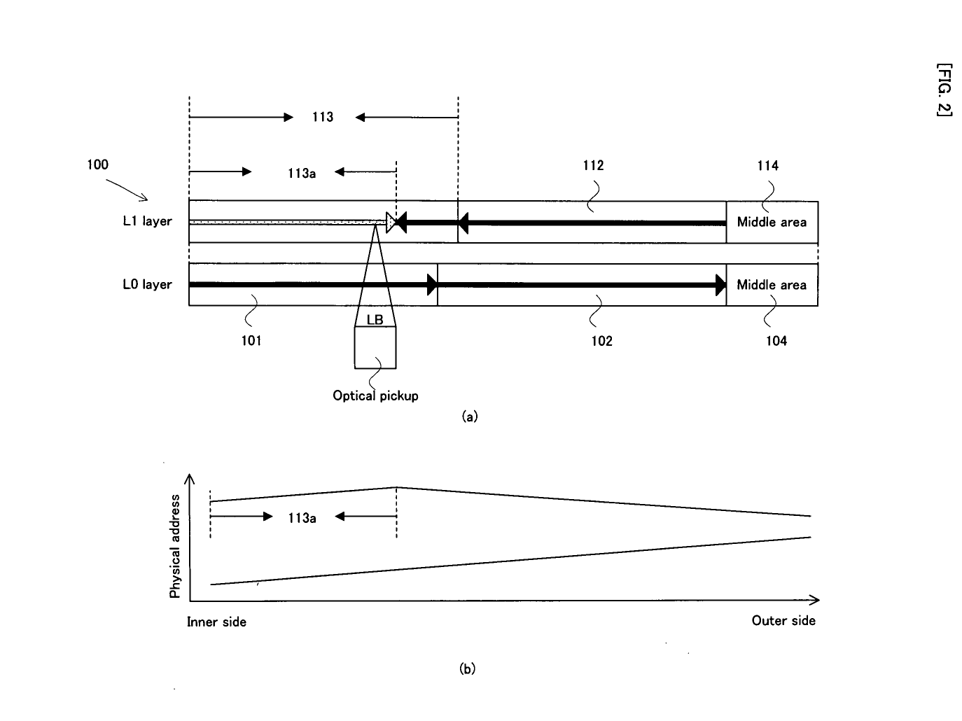

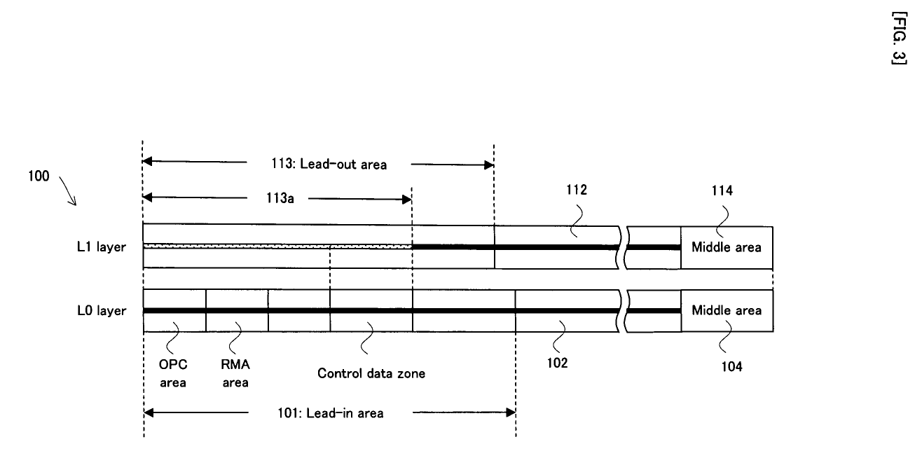

Next, with reference to FIG. 2 and FIG. 3, the optical disc in the first embodiment will be explained in more detail. FIG. 2 are data structure diagrams conceptually showing the data structure of the optical disc of the opposite track path type. FIG. 3 is a data structure diagram showing the data structure of the optical disc of the opposite track path type, in more detail.

As shown in FIG. 2(a), in the optical disc 100 in the first embodiment, the L0 layer is constructed from the lead-in area 101 as one specific example of the “management information area” of the present invention, the data area 102, and the middle area 104, and the L1 layer is constructed from the lead-out area 113 as another specific example of the “management information area” of the present invention, the data area 112, and the middle area 114.

In the lead-in area 102 and the lead-out area 113, various control information is recorded, which is necessary to record the data onto the optical disc 100 or to reproduce the recorded data from the optical disc 100. Moreover, the middle area 104 or 114 functions as an interference area when a target to record the data is changed from the L0 layer to the L1 layer.

Moreover, the optical disc 100 in the first embodiment is the optical disc of the opposite track type. Thus, in the L0 layer, pre-format address information is given so as to increase a physical address as one specific example of the “pre-address” of the present invention from the inner circumferential side to the outer circumferential side In the L1 layer, pre-format address information is given so as to increase the physical address from the outer to the inner circumferential side. The pre-format address information may be given as LPP (Land Pre Pits), or as the cycle of wobble, which indicates the oscillation of the track. Then, various data including contents or the like, such as video data, audio data, PC data or the like, is recorded from the smaller physical address side to the larger physical address side, as a general rule. Namely, in the first embodiment, the data recording is performed by an information recording/reproducing apparatus described later, with reference to the physical address. As a general rule, the data is recorded from the recording area with the smaller physical address to the recording area with the larger physical address. Therefore, the “recording direction” herein is a concept indicating such a direction toward which the physical address substantially increases. Specifically, as shown in thick arrows in FIG. 2(a), the data is recorded from the inner circumferential side to the outer circumferential side in the L0 layer, and the data is recorded from the outer circumferential side to the inner circumferential side in the L1 layer.

Particularly in the first embodiment, in a predetermined area 113a (i.e. one specific example of the “one recording area” of the present invention) in the lead-out area 113 of the L1 layer, the pre-format address information is given so as to increase the physical address from the inner circumferential side to the outer circumferential side. Therefore, in the area 113a, the data (which is the various control information in this case) is recorded toward the same direction as the recording direction of the data in the L0 layer (i.e. from the inner circumferential side to the outer circumferential side).

Namely, as shown in FIG. 2(b), in the L0 layer, the value of the physical address monotonically increases from the inner circumferential side to the outer circumferential side. On the other hand, in an area other than the area 113a, the value of the physical address monotonically increases from the inner circumferential side to the outer circumferential side in the area 113a, and it monotonically increases from the outer circumferential side to the inner circumferential side in an area other than the area 113a.

The area 113a at least includes an area of the L1 layer corresponding to an area of the L0 layer which is firstly irradiated with the laser light LB (i.e. focused-in) by the information recording/reproducing apparatus described later, in recording the data onto the optical disc 100. Namely, if the area of the L0 layer is irradiated with the laser light LB, at least one portion of the area 113a corresponds to the area of the L1 layer located in the same or substantially the same position as that of the area of the L0 layer which is irradiated with the laser light LB.

Incidentally, in FIG. 2(b), it is explained such that the value of the physical address in the area 113a has a different value from that in the L0 layer. However, of course, the value of the physical address in the area 113a may have the same value as that in the corresponding L0 layer. In other words, it may be constructed such that the physical address is assigned in the same manner as a parallel track path method in the area 113a, and that the physical address is assigned in the same manner as the opposite track path method in the area other than the area 113a.

The data structure of the optical disc 100 in the first embodiment will be explained, more specifically. As shown in FIG. 3, the area 113a includes an area of the L1 layer corresponding to a control data zone of the L0 layer (i.e. one specific example of the “particular recording area” of the present invention). Namely, if the optical disc 100 is loaded on the information recording/reproducing apparatus, the information recording/reproducing apparatus firstly irradiates the control data zone with the laser light, to thereby perform the subsequent data recording operation. Then, the area 113a is distributed from the area corresponding to the control data zone, toward the inner circumferential side, up to an area corresponding to the position of the innermost circumference of the optical disc 100.

Of course, if the area that is firstly irradiated with the laser light is an area other than the control data zone, obviously, the area 113a does not have to be the area corresponding to the control data zone.

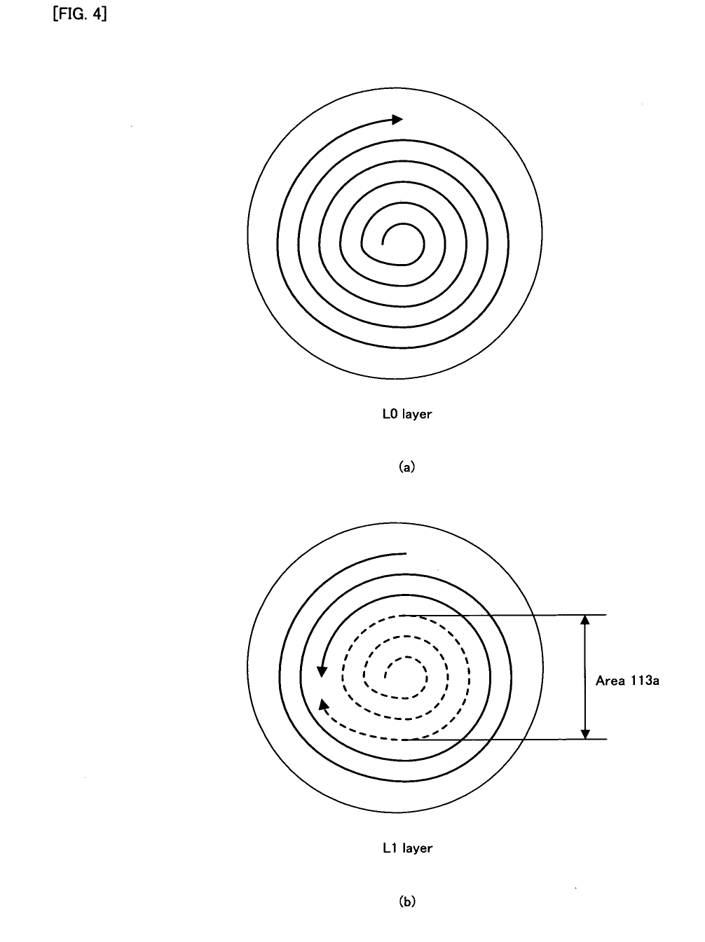

Now, the recording direction of the data (i.e. the direction that toward which the physical address increases) is explained, more conceptually, with reference to FIG. 4. FIG. 4 are plan views conceptually showing the direction of recording the data on the optical disc in the first embodiment.

As shown in FIG. 4, the recording tracks formed on the L0 layer and the L1 layer, are spirally distributed. As shown in FIG. 4(a), in the L0 layer, the recording track is formed clockwise, from the inner circumferential side to the outer circumferential side, and the physical address increases toward an arrow direction. On the other hand, as shown in FIG. 4(b), in the L1 layer, in the area 113a, the recording track is formed clockwise, from the inner circumferential side to the outer circumferential side, and the physical address increases toward an arrow direction, as in the L0 layer. On the other hand, in the area other than the area 113a, the recording track is formed counterclockwise, from the outer circumferential side to the inner circumferential side, and the physical address increases toward an arrow direction, as opposed to the L0 layer. Namely, various data is recorded toward the arrow direction, in accordance with the distribution of the physical address.

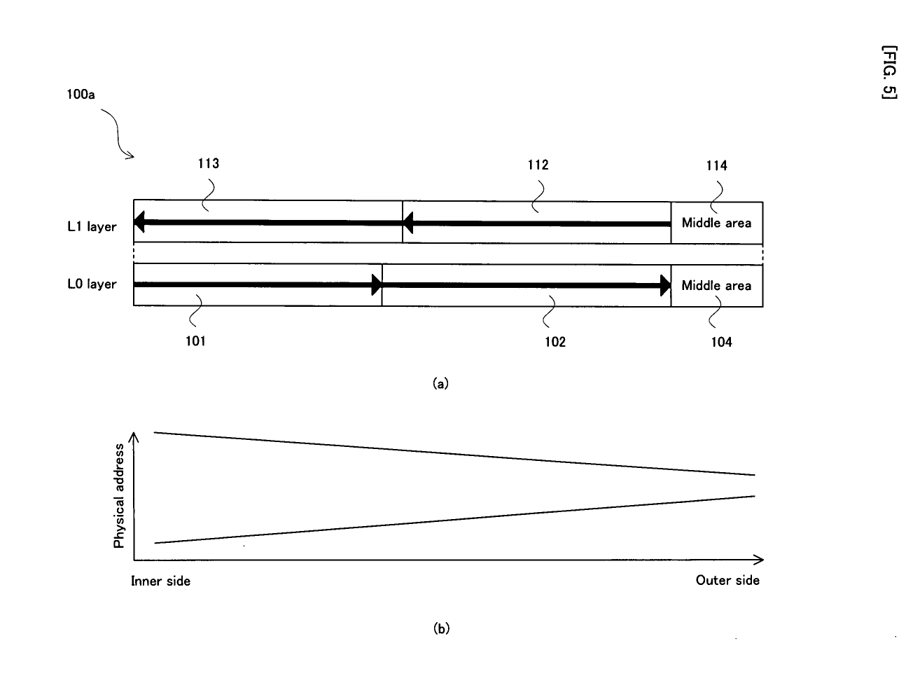

Now, in order to explain the excellent effect that the optical disc 100 has in the embodiment, a comparison example of the optical disc in the embodiment will be explained, with reference to FIG. 5. FIG. 5 are data structure diagrams conceptually showing an example of the data structure of an information recording medium in the comparison example.

As shown in FIG. 5(a), in an optical disc 100a of the opposite track path type, the physical address monotonously increases from the inner circumferential side to the outer circumferential side in an arbitrary area of the L0 layer, and the physical address monotonously increases from the outer circumferential side to the inner circumferential side in an arbitrary area of the L1 layer. Namely, in the optical disc 100a in the comparison example, the physical address is assigned as shown in FIG. 5(b). Then, if the control data zone of the L0 layer is irradiated with the laser light LB, the laser light LB is sometimes focused-in on the corresponding area of the L1 layer by mistake. At this time, the information recording/reproducing apparatus starts to recognize the physical address of the focused-in area, and continue the recording operation in the L1 layer.

The operation in that case will be specifically explained below. As shown in FIG. 5(b), the address value in the L0 layer increases toward the outer circumferential side (i.e. the side of the middle area 104), wherein the value of the physical address of the L1 layer decreases toward the outer circumferential side (i.e. the side of the middle area 114). Then, if the laser light LB is focused-in on the L1 layer by mistake, the information recording/reproducing apparatus starts to read the various control information, which is supposed to be located on the more inner circumferential side (i.e. which is supposed to have the much smaller value of the physical address). This is because the value of the physical address in the focused-in position in the L1 layer is larger than the address value of the control information to be read originally in the L0 layer. However, in the L1 layer, since the physical address increases toward the inner circumferential side, the information recording/reproducing apparatus displaces the optical pickup to the more inner circumferential side so as to search for the proper physical address. Thus, this operation is continued until the displacement of the optical pickup is restricted by a stopper, located on the innermost circumferential side in the end, and that is, the operation of the optical pickup goes out of control. This situation is not preferable, from the viewpoint of the proper recording operation or the quick recording operation.

However, in the case of the optical disc in the first embodiment, in the area 113a of the L1 layer, the physical address monotonously increases from the inner circumferential side to the outer circumferential side, as in the L0 layer. Therefore, even if the laser light LB is focused-in on the L1 layer by mistake, the information recording/reproducing apparatus does not further search toward the area on the inner circumferential side, as described above. Alternatively, even if it searches, the operation of the optical pickup does not go out of control, and as a result, there is not any disadvantage that the displacement is restricted by the stopper located on the innermost circumference. Moreover, since the various control information to be read originally is not recorded in the L1 layer, the information recording/reproducing apparatus cannot read the various record information, and it can judge that the optical disc is a defective or improper.

At this time, in the area 113a including the area corresponding to the control data zone, there may be recorded the data that is difficult or impossible to be read by at least conventional information recording/reproducing apparatus. The conventional information recording/reproducing apparatus herein is an information recording/reproducing apparatus which does not support the multilayer type optical disc having the plurality of recording layers, for example. Moreover, data which cannot be error-corrected by using an ECC (Error Correction Code) may be also recorded as the data that is difficult or impossible to be read. By this, even if the laser light is focused-in on the L1 layer by mistake, the data in the focused-in area cannot be read, and as a result, it can be judged that the optical disc is a defective or improper.

Then, in this case, if the optical disc is reloaded, automatically by the information recording/reproducing apparatus, or by the operation of a user, it is possible to properly perform the focus-in on the L1 layer, to thereby continue the subsequent proper recording operation. At this time, if there is such a disadvantage that the laser light is focused-in on the L1 layer again, the optical disc may be reloaded. Alternatively, it may be constructed such that it is judged that the optical disc is a completely unrecordable disc, and that an instruction to load another optical disc is given to the user.

Moreover, in the area 113a of the L1 layer, a layer flag may be also recorded. The layer flag includes information capable of judging whether the recording layer in which the layer flag is recorded is the L0 layer or the L1 layer. Therefore, in the case of the information recording/reproducing apparatus which supports the multilayer type optical disc, it is possible to recognize that the laser light is focused-in on the L1 layer by mistake, by reading the laser flag, in the case where it originally desires to focus-in the laser light on the L0 layer. Therefore, it is possible to continue the proper recording operation by ejecting the optical disc 100 or by focusing-in the laser light on the L0 layer again, as described above.

Moreover, in addition to or instead of the layer flag, version information indicating the version of the optical disc may be recorded. For example, in the area 113a, the version information indicating version which is different from the original version of the L0 layer, may be recorded. Even in this construction, it is possible to recognize that the laser light is focused-in on the L1 layer by mistake, by reading the version information, in the case where it originally desires to focus-in the laser light on the L0 layer. Therefore, it is possible to continue the proper recording operation_by ejecting the optical disc 100 or by focusing in the L0 layer again, as described above.

As described above, even if the layer flag or the version flag is recorded, it is obviously important that the direction toward which the physical address increases or decreases in the area 113a is the same as that of the L0 layer. Namely, since the direction toward which the physical address increases or decreases in the area 113a is the same as that of the L0 layer, it is possible to prevent the out-of-control operation of the optical pickup, and as a result, it is possible to read the layer flag or the version flag.

In any cases, it is possible to continue the proper recording operation, by constructing the optical disc such that the direction toward which the physical address increases or decreases (i.e. the recording direction of the data) in the area 113a of the L1 layer is the same as that of the L0 layer, as in the optical disc in the first embodiment. Moreover, as described above, since it is possible to avoid such a wasteful operation that the searching is performed with respect to the L1 layer until the displacement of the optical pickup is restricted by the stopper, for example, it is possible to realize the quick recording operation. Alternatively, it is possible to suppress the out-of-control operation of the optical pickup. In particular, even in the case of the existing information recording/reproducing apparatus which does not support the optical disc having two or more recording layers, if the laser light is focused-in on the area 113a by mistake, it can judge that the optical disc is a defective disc or improper optical disc. Therefore, it is possible to take a proper approach, such as reloading, for example, thereby it is possible to continue the proper recording operation.

Incidentally, in the embodiment, the area 113a is distributed in wide recording areas, from the area corresponding to the control data zone to the area located on the innermost circumferential side. However, from the viewpoint of preventing such a disadvantage that the searching is performed with respect to the L1 layer until the displacement of the optical pickup is restricted by the stopper located on the innermost circumferential side, as described above, it is only necessary to regard the area corresponding to at least the control data zone, as the area 113a.

Moreover, in the above-mentioned embodiment, the optical disc having the two recording layers is explained as a specific example. However, of course, even an optical disc having three or more recording layers can adopt the same construction.

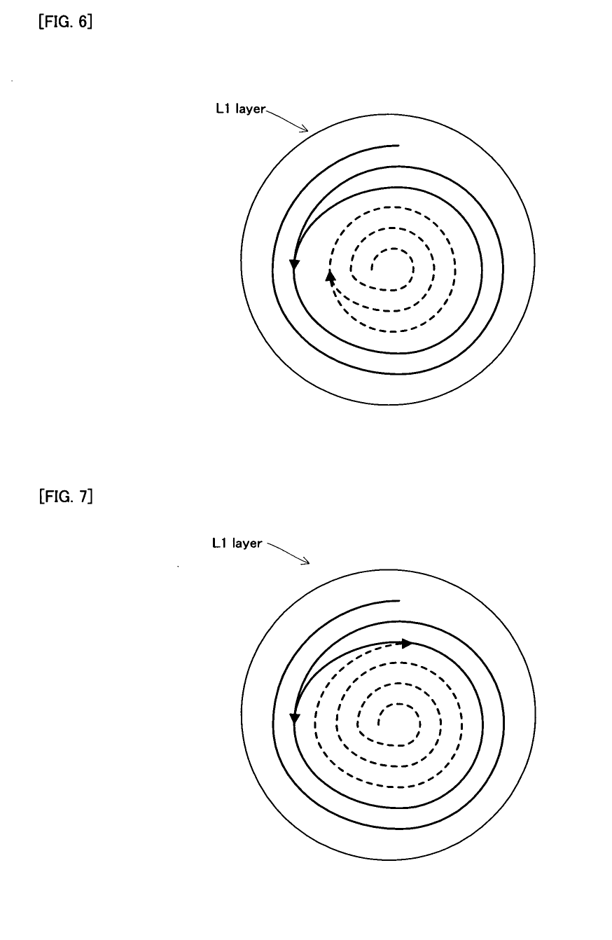

Next, with reference to FIG. 6 to FIG. 9, an explanation will be given for specific aspects of the distribution of the recording track formed in the L1 layer. FIG. 6 to FIG. 9 are plan views conceptually showing aspects of the distribution of the recording track formed in the L1 layer of the optical disc in the embodiment.

As shown in FIG. 6, the recording track corresponding to the area 113a may converge as one spiral (or one concentric circle), wherein the recording track corresponding to the other area other than the area 113a may converge to another spiral (or another concentric circle) which is different from the one spiral. By virtue of such construction, it is possible to properly differentiate the area 113a and the other area.

As shown in FIG. 7, the recording track corresponding to the area 113a and the recording track corresponding to the other area other than the area 113a may converge to the same spiral. In this case, the area on the outermost circumference of the area 113a and the area on the innermost circumference of the other area other than the area 113a may converge in the same position, or in different positions, as shown in FIG. 7. By virtue of such construction, it is possible to properly differentiate the area 113a and the other area.

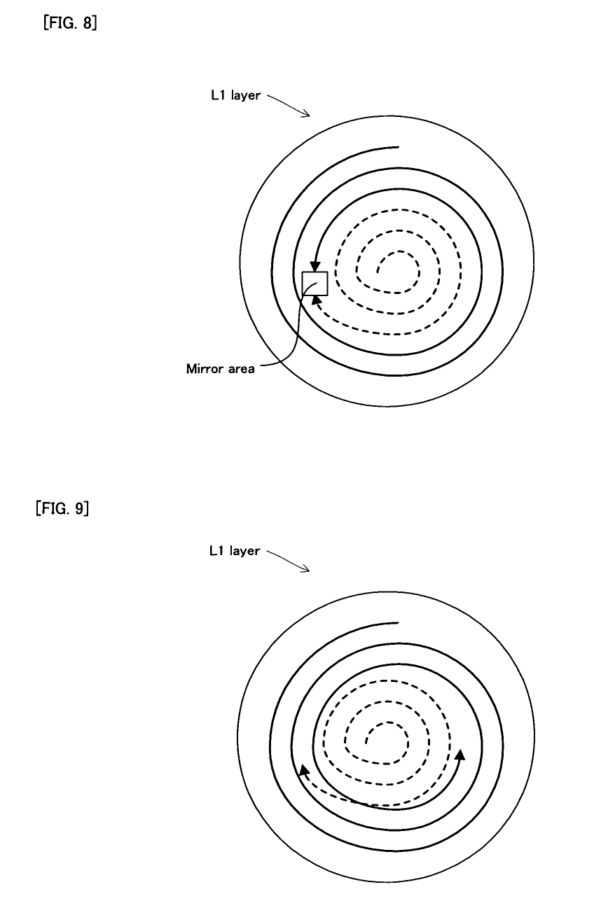

As shown in FIG. 8, the boundary portion between the recording track corresponding to the area 113a and the recording track corresponding to the other area other than the area 113a may be a mirror area. The mirror area herein indicates a recording area in which the data is not recorded at all. Even by virtue of such construction, it is possible to properly differentiate the area 113a and the other area. Moreover, such construction also has an advantage that the optical disc 100 can be manufactured, relatively easily.

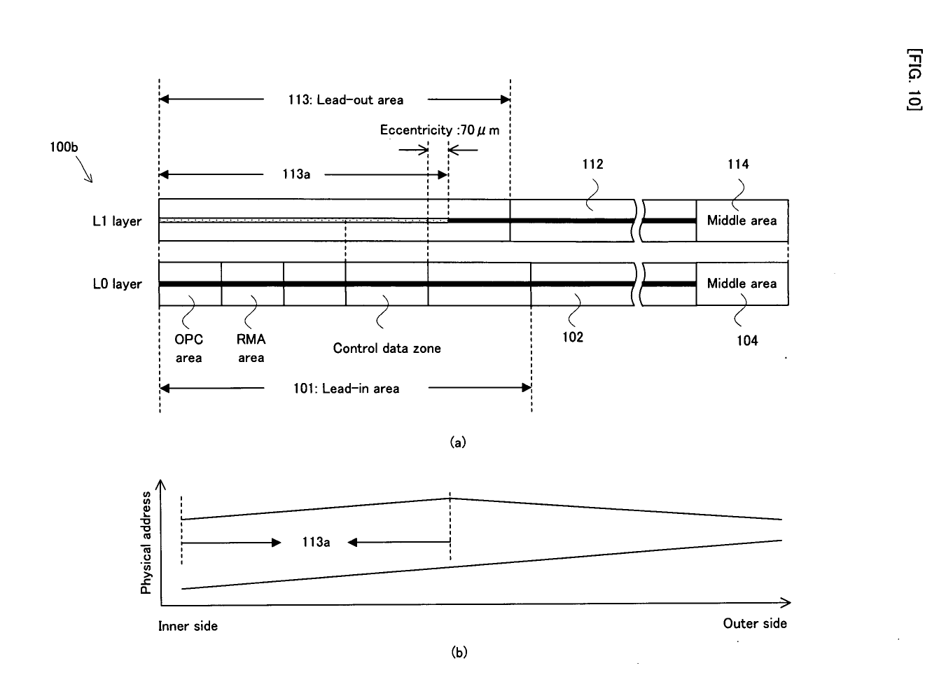

As shown in FIG. 9, the recording track corresponding to the area 113a and the recording track corresponding to the other area other than the area 113a may cross each other at an arbitrary position. Even by virtue of such construction, since the data is recorded along the recording track, it is possible to properly differentiate the area 113a and the other area. Moreover, since it is only necessary to form each recording track, independently, such construction also has an advantage that the optical disc 100 can be manufactured, relatively easily.

Of course, the present invention is not limited to the aspects of the recording track as shown in FIG. 6 to FIG. 9. Namely, it is obvious that the scope of the present invention also includes an aspect in which the area 113a and the other area can be properly differentiated or an aspect in which the recording direction can be changed (i.e. an aspect in which the data recording direction of the area 113a and that of the L0 layer can be made equal).

### (2) Second Embodiment

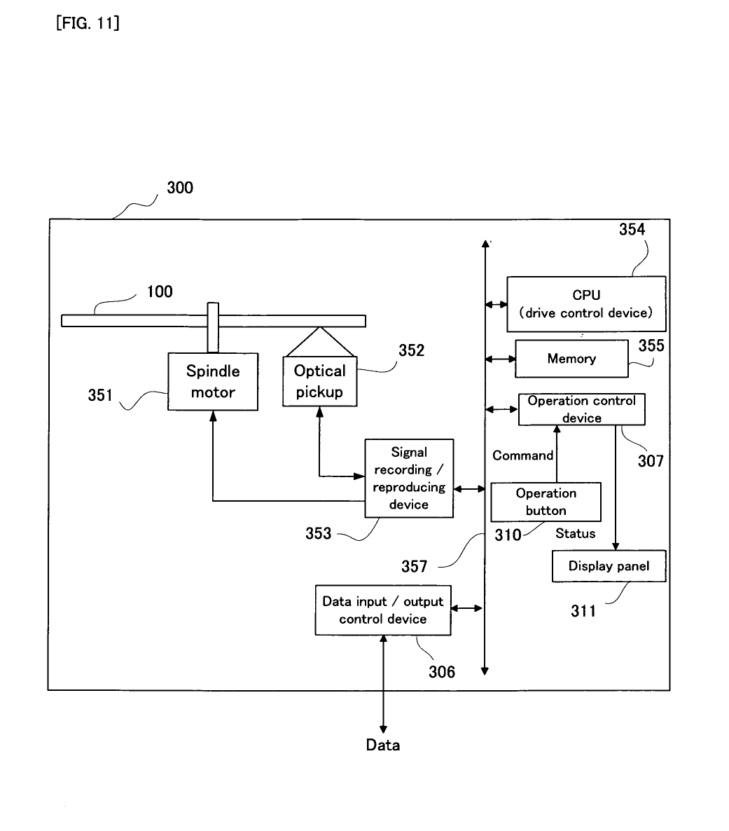

Next, with reference to FIG. 10, a third embodiment of the information recording medium of the present invention will be explained.

FIG. 10 are data structure diagrams conceptually showing the data structure of an optical disc in the second embodiment of the information recording medium of the present invention.

As shown in FIG. 10, an optical disc 100b in the second embodiment can also adopt the same data structure as that of the optical disc in the first embodiment. Namely, the direction toward which the physical address increases or decreases (i.e. the data recording direction) in the area 113a including the area of the L1 layer corresponding to the area that is firstly irradiated with the laser light in the L0 layer, is the same as that of the L0 layer.

Particularly in the second embodiment, the boundary portion (the edge portion) on the outer circumferential side of the area 113a is located outer than the boundary portion (the edge portion) on the outer circumferential side of the area that is irradiated with the laser light in the L0 layer. Specifically, the boundary portion (the edge portion) on the outer circumferential side of the area 113a is located about 70 μm outer than the boundary portion (the edge portion) on the outer circumferential side of the area that is irradiated with the laser light in the L0 layer. This size of “70 μm” is the size of an acceptable eccentricity according to the standard, in a DVD having a plurality of recording layers.

As described above, by setting the size of the area 113a in which the control information is not recorded with considering the eccentricity, it is possible to suppress the disadvantage more properly, such as the out-of-control operation of the optical pickup, when the laser light LB is focused-in on the L1 layer by mistake. Namely, there is a possibility that the control data zone of the L0 layer and the corresponding area 113a do not properly correspond to each other with respect to the laser light because the eccentricity occurs. At this time, as in the second embodiment, if the size of the area 113a is set large in advance, then, it is possible to realize the optical disc on which both the area corresponding to the control data zone and the area 113a have the same direction to which the physical address increases even if the eccentricity occurs.

Incidentally, if the size of the eccentricity of the optical disc 100 is known in advance, it is also possible to shift the boundary portion (the edge portion) of the area 113a by the amount of eccentricity, to the outer circumferential side, instead of the size of 70 μm.

(Information Recording/Reproducing Apparatus)

Next, with reference to FIG. 11, an explanation will be given for the structure and the operation of an embodiment of the information recording apparatus for recording or reproducing the data by using the information recording medium of the present invention. FIG. 11 is a block diagram showing an information recording/reproducing apparatus 300 in the embodiment of the present invention. Incidentally, the information recording/reproducing apparatus 300 has a function of recording the record data onto the optical disc 100 and a function of reproducing the record data recorded on the optical disc 100.

With reference to FIG. 11, the inner structure of the information recording/reproducing apparatus 300 will be discussed. The information recording/reproducing apparatus 300 is an apparatus for recording the information onto the optical disc 100 and reading the information recorded on the optical disc 100, under the control of a processor 354.

The information recording/reproducing apparatus 300 is provided with: the optical disc 100; a spindle motor 351; an optical pickup 352; a signal recording/reproducing device 353; the CPU (drive control device) 354; a memory 355; a data input/output control device 306; an operation control device 307; an operation button 310; a display panel 311; and a bus 357.

The spindle motor 351 is intended to rotate and stop the optical disc 100, and operates upon accessing the optical disc. More specifically, the spindle motor 351 is constructed to rotate and stop the optical disc 100 at a predetermined speed, under spindle servo from a not-illustrated servo unit or the like.

The optical pickup 352 is intended to perform the recording/reproduction with respect to the optical disc 100, and is provided with a laser device, a lens, and the like. More specifically, the optical pickup 352 irradiates the optical disc 100 with a light beam, such as a laser beam, as reading light with a first power upon reproduction, and as writing light with a second power upon recording, with it modulated.

The signal recording/reproducing device 353 controls the spindle motor 351 and the optical pickup 352, to thereby perform the recording/reproduction with respect to the optical disc 100.

The memory 355 is used in the general data processing on the disc drive 300, including a buffer area for the record/reproduction data, an area used as an intermediate buffer when data is converted into the data that can be used on the signal recording/reproducing device 353, and the like. Moreover, the memory 355 is provided with: a ROM area into which a program for performing an operation as a recording device is stored; a buffer used for compression/decompression (or encoding/decoding) of video data; a RAM area into which a parameter required for the operation of the program or the like is stored; and the like.

The CPU (drive control device) 354 is connected to the signal recording/reproducing device 353 and the memory 355 through the bus 357, and controls the entire information recording/reproducing apparatus 300 by giving an instruction to each controlling device. In general, software for operating the CPU 354 is stored in the memory 355.

The data input/output control device 306 controls the input/output of the data from the exterior with respect to the information recording/reproducing apparatus 300, to thereby perform storage to and export from the data buffer on the memory 355. If the input/output of the data is a video signal, the data input/output control device 306 compresses (encodes) the data received from the exterior in a MPEG format, for example, and outputs it to the memory 355, upon data inputting. Upon data outputting, it decompresses (decodes) the encoded data in the MPEG format or the like received from the memory 355, and outputs it to the exterior.

The operation control device 307 receives an operation instruction and performs display with respect to the information recording/reproducing apparatus 300, and transmits an instruction by the operation button 310, such as an instruction to record or reproduce, to the CPU 354, and outputs the operation state of the information recording/reproducing apparatus 300, such as during recording and during reproduction, to the display panel 311, such as a fluorescent tube.

One specific example of the information recording/reproducing apparatus 300, as explained above, is household equipment, such as recorder equipment for recording and reproducing video images. The recorder equipment records a video signal from a broadcast reception tuner and an external connection terminal, onto a disc, and outputs the video signal reproduced from the disc to external display equipment, such as a television. The operation as the recorder equipment is performed by executing a program stored in the memory 355, on the processor 354.

Particularly in the embodiment, since the direction to which the physical increases (i.e. the recording direction of the data) in the area 113a of the L1 layer is the same as that of the L0 layer on the optical disc 100, even if the laser light LB is focused-in on the L1 layer by mistake, it is possible to continue the proper recording operation.

Moreover, in the above-mentioned embodiments, the optical disc 100 is explained as one example of the information recording medium, and the recorder related to the optical disc 100 is explained as one example of the information recording apparatus. The present invention, however, is not limited to the optical disc and the recorder thereof, and can be also applied to other various information recording media and the recorder thereof which support high-density recording and high transfer rate.

The present invention is not limited to the above-described embodiments, and various changes may be made, if desired, without departing from the essence or spirit of the invention which can be read from the claims and the entire specification. An information recording medium which involves such changes, is also intended to be within the technical scope of the present invention.

### INDUSTRIAL APPLICABILITY

The information recording medium according to the present invention can be applied to a high-density recording medium, such as a DVD, for example.

1. An information recording medium comprising:
a first recording layer in which record information is recorded toward one direction directed from an inner circumferential side to an outer circumferential side, or directed from the outer circumferential side to the inner circumferential side, by irradiating laser light thereon; and
a second recording layer in which the record information is recorded toward another direction which is different from the one direction, by irradiating the laser light thereon,
directions of recording the record information being equal, in a particular recording area for focus-in of the laser light in said first recording layer and in at least one recording area of said second recording layer corresponding to the particular recording area.

2. The information recording medium according to claim 1, wherein
a pre-address indicating at least one of a position to which the record information is recorded and a direction toward which the record information is recorded is recorded in each of said first and second recording layers, and
the pre-address of a predetermined recording point in each of the particular area and the one recording area increases, as the predetermined recording point is displaced toward the one direction.

3. The information recording medium according to claim 1, wherein the pre-address recorded in the one recording area is the same as the pre-address recorded in the particular recording area.

4. The information recording medium according to claim 1, wherein a layer flag for identifying each of said first and second recording layers is recorded in the one recording area.

5. The information recording medium according to claim 1, wherein record information which is not error-correctable is recorded in the one recording area.

6. The information recording medium according to claim 1, wherein
at least said second recording layer has a spiral or concentric recording track, and the record information is recorded along the recording track, and
a recording track in the one recording area converges to one spiral or concentric circle, and a recording track in another recording area of said second recording layer other than the one recording area converges another spiral or concentric circle which is different from the one spiral or concentric circle.

7. The information recording medium according to claim 1, wherein
at least said second recording layer has a spiral or concentric recording track, and the record information is recorded along the recording track, and
a recording track in the one recording area and a recording track in another recording area of said second recording layer other than the one recording area converge a same spiral or concentric circle in boundary portion between the recording track in the on recording area and the recording track in the another recording area.

8. The information recording medium according to claim 1, wherein
at least said second recording layer has a spiral or concentric recording track, and the record information is recorded along the recording track, and
a mirror area in which the record information is not recorded is provided in a boundary portion between a recording track in the one recording area and a recording track in another recording area of said second recording layer other than the one recording area.

9. The information recording medium according to claim 1, wherein
at least said second recording layer has a spiral or concentric recording track, and the record information is recorded along the recording track, and
a recording track in the one recording area is distributed across a recording track in another recording area of said second recording layer other than the one recording area.

10. The information recording medium according to claim 1, wherein at least one of the particular recording area and the one recording area is at least partial portion of a management information area to record therein management information for managing the record information recorded on said information recording medium.

11. The information recording medium according to claim 1, wherein the one recording area is larger than the particular recording area.
